(19) United States
(12) Patent Application Publication
(10) Pub. No.: US 2004/0127276 A1
(43) Pub. Date: Jul. 1, 2004

(54) Electronic game and method for playing a game based upon removal and replacing playing cards in the game

(76) Inventor: Ernest W. Moody, Las Vegas, NV (US)

Correspondence Address: JOHN EDWARD ROETHEL, 2290 S. JONES BLVD. #100, LAS VEGAS, NV, 89146, US

(21) Appl. No.: 10/334,876

(22) Filed: Dec. 30, 2002

(51) Int. Cl. G06F 17/00

(52) U.S. Cl. 463/13

(57) ABSTRACT

Novel payout methods are provided in a video device and method in which playing cards are displayed in a matrix. If a predetermined winning card combination is obtained in any column or row of the matrix, an award is issued and the cards of the winning combination are removed from the matrix. The matrix may be reconstituted by moving the remaining cards. Open card locations in the matrix are filled with other cards and the matrix is reanalyzed to determine if other winning card combinations have been obtained. The removal and replacement repeats until there are no more winning card combinations in the matrix. The player is issued an award based upon the winning combinations obtained.

### BACKGROUND OF THE INVENTION

Electronic games have become a popular form of entertainment. These games may be casino, wagering type games where a player deposits money in the form of coins, gaming tokens or paper currency either into a coin acceptor-tester or bill acceptor (“the coin-in”). The coins and gaming tokens are collected in a reservoir inside the gaming machine (“the hopper”) while the paper currency is collected in the bill acceptor inside the gaming machine. If the coins, gaming tokens or paper currency are validated as authentic, the player accrues the appropriate number of playing units (“credits”) on a credit meter on the gaming machine depending on the denomination of the wager as set on the gaming machine. For example, a twenty-five cent gaming machine will accrue four credits for each dollar deposited into the gaming machine by way of the coin head or the bill acceptor.

After accruing credits on the credit meter, the player determines how many credits he wishes to wager on the next spin of the slot reels (“total bet”) and then spins the reels by pressing the spin button or by pulling a handle. When prompted by pushing a spin button or pulling a handle, a controlling processor randomly selects an outcome and controls a display to display the outcome. The display may consist of electromechanical reels or a VRT or plasma display. In many modern machines, the outcome is in the form of a 3×3 or 3×5 matrix of game symbols. The processor compares the outcome to determine if one or more predetermined winning outcomes have been obtained. For each winning outcome, which may be the symbol combination along any enabled pay line for the machine or sets of scattered symbols, the processor issues an award to the player. After the award based upon the outcome of the spin has been issued based upon the display of symbols, the player inputs another wager and prompts a further spin.

In some slot machines, certain symbol combinations can trigger a bonus event, such as a bonus screen through which the player can win an additional award.

In another unrelated, prior art game referred to as “Bedazzled” and available for play on the Internet, there is a computer generated matrix of game symbols, each randomly assigned into a coordinate of the matrix defined by horizontal rows and vertical columns. To play the game the player may, using a computer keyboard or mouse, exchange the positions of adjacent symbols in a horizontal row to obtain a set or sets of three or more like symbols in a horizontal row or a vertical column. When a set is created, the computer controls the game to issue the player an award of points based upon the symbol set(s), remove the matching set(s) from the display, shift the symbols above the removed set(s) downward into the positions of the removed symbols and reconstitute the matrix by selecting and displaying at the upper row of the matrix replacement symbols. The player continues with the game for so long as sets can be assembled by exchanging the positions of horizontal adjacent symbols. By exchanging symbols the player can amass game points.

A drawback of this game is that it is not a casino-type wagering game and thus provides no mechanism by which a player may make a wager. In this regard the Bedazzled game is not configured to assign winning awards based upon player wagers to meet regulatory or commercial requirements.

There is a need to provide players with an ever increasing number of entertainment options in the form of new games. It is an object of the present invention to provide a new game in the form of a game matrix where awards are based upon and issued for obtaining predetermined winning outcomes based on playing card combinations, arranged for example in adjacent playing card combinations such as horizontally or vertically.

It is a further object of the present invention to provide a game where winning playing card combinations are removed from the matrix and are replaced to re-constitute the matrix and possibly define more winning playing card combinations, still based upon the original wager.

It is another object to configure a game having the above objects which can meet gaming regulatory as well as commercial performance standards.

The present invention enables the casino to attract and retain players interested in playing an innovative slot game and the player enjoys a new method of receiving an award.

### BRIEF DESCRIPTION OF THE DRAWINGS

These and other features and advantages will become apparent as the same becomes better understood with reference to the specification, claims and drawings wherein;

FIG. 1 illustrates a game device according to the present invention having a game display;

FIG. 2 shows a game display with playing cards for purposes of illustration; and

FIG. 3 is a logic diagram for the game.

### DETAILED DESCRIPTION OF THE PREFERRED EMBODIMENTS

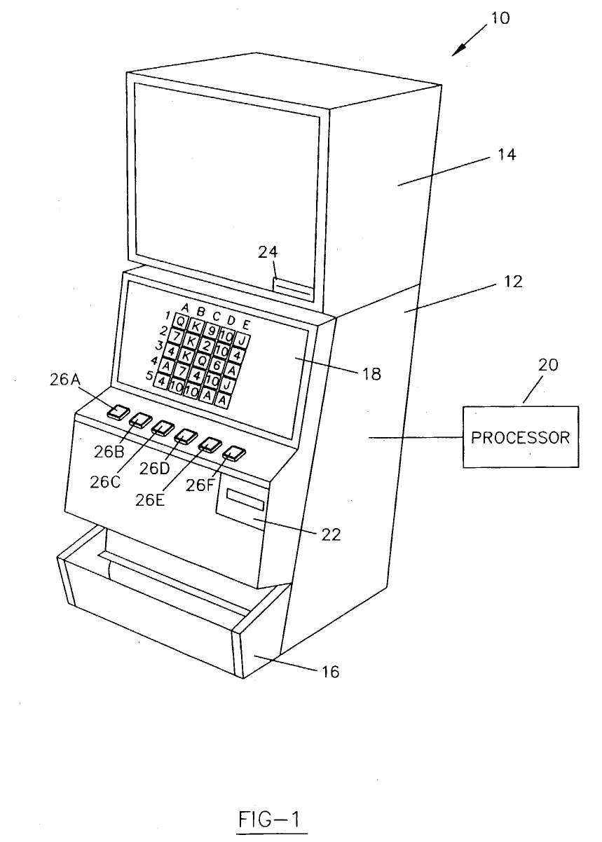

Turning to FIG. 1, there is shown a game apparatus 10 according to an embodiment of the present invention. This apparatus 10 may be specially constructed for the required purpose or it may comprise a general purpose computer as selectively activated or reconfigured by a computer program stored in the computer. The method and device described herein are not dependent upon a particular computer or other apparatus. Various general purpose machines may be used with programs written in accordance with the teachings herein, or it may prove more convenient to construct more specialized apparatus to perform the required method steps. The required structure for a variety of -these machines will appear from the description given.

The apparatus 10, shown embodied as an upright gaming device, has a housing 12 which includes an upper portion 14 which may include graphics and/or backlit panels to identify the game or to attract players and other information for the player. For example, the upper portion 14 may display the pay table for the game as hereinafter described. The housing 12 is adapted to sit on a slot machine cabinet (not shown) or the like. At the bottom thereof, the housing 12 mounts a payout tray 16 which captures coins/tokens dispensed by the apparatus 10. The housing 12 also mounts and supports a game display 18 which is an electronic video display such as a VRT, plasma or other type of electronic display as is known in the art.

Disposed within the housing, according to the present embodiment, is a game processor 20. As will hereinafter be described, the processor 20 controls the various operations and play of the game according to the present invention as well as the display 18. The apparatus 10 may also include a token acceptor (not shown) of the type known in the art and/or a cash validator 22 of known construction. Cash or script bills inserted into the validator 22 convert the cash value into a corresponding number of credits based upon the denomination of the gaming machine, e.g. 5¢, 25¢ or $1.00 as is known in the art. The processor 20 controls the display 18 to display at a credit meter (not shown) the accumulated credits available for play of the game. Thus the player can accumulate credits for play by inserting cash or script into the validator 22.

The apparatus 10 may also mount a player tracking module 24 to read an instrument, such as a machine readable player tracking card (not shown) by which the play of the player at the apparatus 10 may be monitored for purposes well known in the art.

To control play of the game as hereinafter described, data input and prompting apparatus are provided. As shown in FIG. 1 for this purpose the housing 12 mounts a plurality of control buttons 26a-f. Button 26a is provided for the player to select which pay lines, defined as vertical columns in a game matrix displayed at the display 18, the player wishes to wager upon. Button 26b provides for the player to enter the desired wager per selected pay lines in one unit increments between a minimum (1 unit/pay line) and a maximum (e.g. 5 units/pay line). Button 26c is a Deal Button to prompt play of the game, i.e. play a hand of the game, button 26d is a Max Bet button whereby the player wagers on all pay lines to the maximum limit and simultaneously prompts play of a hand and button 26e is a pay table button which, if depressed causes the display 18 to show the payouts and the winning outcomes for the game. Finally button 26f is a “Help” button which, if depressed, causes the display to show the rules of the game and other information to help the player. These buttons 26a-f may be embodied as areas on a touch screen display 18 as well. Where the game is played with a personal computer such as a novelty game or an Internet game, the data input apparatus may be a keyboard or mouse.

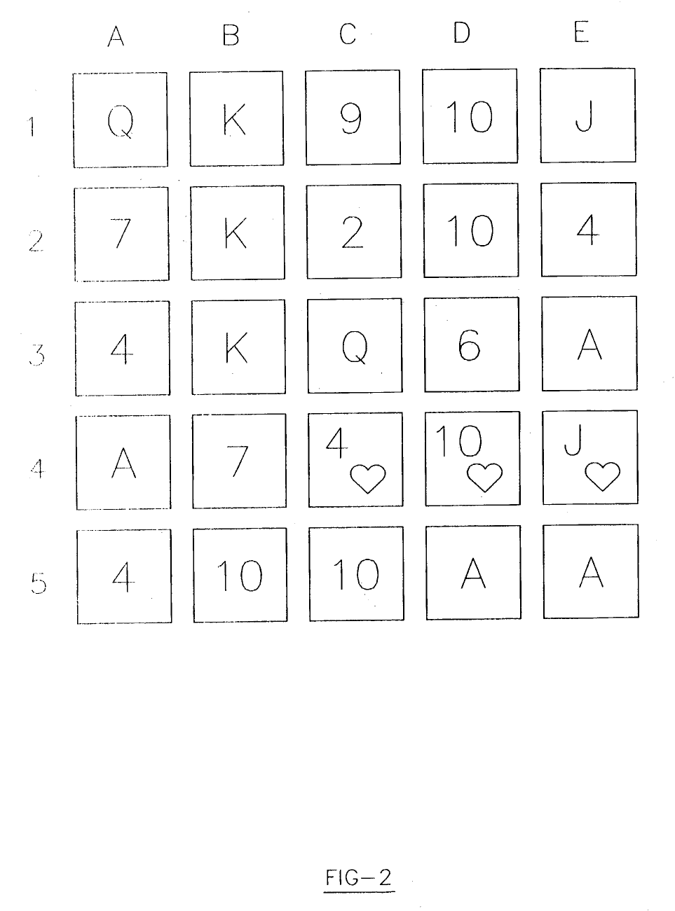

To play the game, the player first accrues credits by, for example, inserting a cash note into the validator 22. The number of credits available for play are displayed at an appropriate credit meter (not shown). Using the data input apparatus, the player selects the pay lines he wishes to wager upon. With reference to FIGS. 1 and 2 there is shown the 5×5 game matrix for the play of the game which also defines five vertical columns A-E and five horizontal rows 1-5. According to one embodiment of the device and method of the present invention, the 5×5 matrix defines five vertical pay lines and five horizontal pay lines corresponding to the columns A-E and rows 1-5 for a total of ten pay lines. Accordingly the player may wager upon all or some of the pay lines. To allocate wagers of less than the maximum, e.g. five units/pay line for a total of fifty units, an allocation protocol may be adopted. For example, wagers may be allocated to the pay lines A-E and 1-5 such that a wager of ten units allocates one units to each column and row.

Data representing the game playing cards is stored in a suitable data structure 36 such as a random access memory (RAM), or other accessible data storage device including a disk, compact disk or the like. The data structure is configured to represent a deck of playing cards. The deck may be a standard deck of fifty-two playing cards or a Joker's Wild deck of fifty-three cards (standard deck plus a Joker) or any other deck configuration. Data (i.e. playing card) selection may be accomplished through various known means such random number selection and data mapping as is known in the art. Suffice it to say that the processor 20 and data structure 36 are configured such that when game play is prompted the processor 20, in effect, randomly selects from the deck the playing cards for display into each card location of the game matrix displayed at the game display 20.

While the data structure 36 may store data representing one or multiple decks of cards, it is preferred that the data structure 36 is configured such that data representing at least one deck of playing cards is assigned for each vertical column A-E of the game matrix. The processor 20 selects and displays cards from the assigned deck for each corresponding column A-E for game play as hereinafter described. Thus, for horizontal rows 1-5 it is possible to have a five of a kind, e.g. five Aces, and even five cards of the same suit and value, e.g. five Aces of Hearts, since each column has cards selected from its own deck(s).

As shown in FIG. 2, the game matrix displayed at the display 20 may be in matrix-form having rows R and columns C where C and R are greater than or equal to 3. Preferably, as shown in FIG. 2 the game matrix is a 5×5 matrix defining twenty-five card locations each having a designation (for purposes of the following description) defined by its intersecting column and row, e.g. card location A3. After the player has set his wager, play of the game hand is prompted. The processor 20 randomly selects data from the data structure 36 representing playing cards and assigns and displays at each card location a playing card. Each column A-E and each row 1-5 would therefore display an outcome representing a five card poker hand.

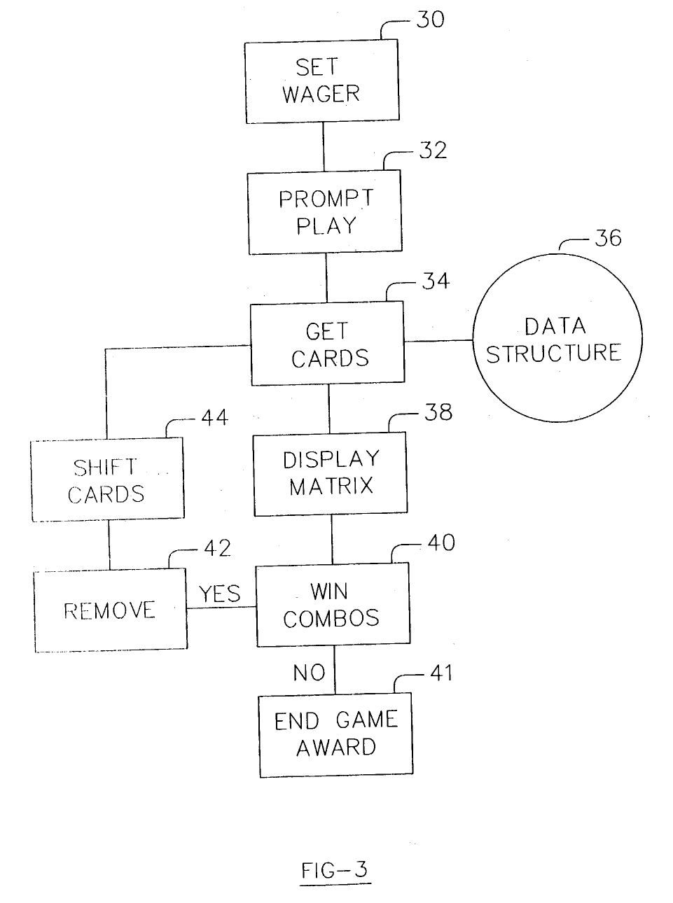

With reference to FIGS. 1-3, the play of the game according to the method and the device of the present invention will now be described. At 20 the player makes their desired wager. For purposes if illustration it will be assumed that the player has wagered a maximum amount, e.g. fifty units: five units for each of the ten pay lines (five vertical columns A-E and five horizontal rows 1-5). At 32 play of a hand is prompted by the wager of the maximum amount. When prompted, the processor 20 at 34 accesses the data structure 36 to randomly select card data and control the display 18 to display at each card location of the game matrix at 38 a playing card. With reference to FIG. 2, and for purposes of this example, the initial selection has resulted in the game matrix having a configuration including the following cards:

| | A | B | C | D | E |
|---|---|---|---|---|---|
| 1 | Q | K | 9 | 10 | J |
| 2 | 7 | K | 2 | 10 | 4 |
| 3 | 4 | K | Q | 6 | A |
| 4 | A | 7 | 4♥ | 10♥ | J♥ |
| 5 | 4 | 10 | 10 | A | A |

While each card in the matrix would have a suit as well, as is conventional with standard playing cards, only certain cards are shown to have suit designations for the purposes of this illustration.

At 40 the processor 20 compares the playing cards and their positions to determine if the initial displayed outcome has any predetermined winning playing card combinations for which the player is entitled to an award. For this purpose data representing a schedule of winning card combinations and a corresponding award therefor is stored in the data structure 36. As an example, the schedule may include the following winning outcome combinations:

Three of a Kind

Three Card Straight

Three Card Flush

Four of a Kind

Four Card Flush

Five Card Full House

Five Card Straight

Five Card Flush

Five Card Straight Flush

Five Card Royal Flush

Five of a Kind

Five of the Same Card

Any suitable amount may be paid for each of the winning outcome combinations and would generally be based on the amount wagered by the player on the pay line on which the winning outcome combination appeared.

Other card combinations may also be used as winning combinations, e.g. Four Card Straight Flush, Three Card Straight Flush and the like. For any winning combination only the highest ranking combination would preferably be entitled to the award, e.g. a Four Card Straight would not also award for any included Three Card Straight.

In one embodiment of the present invention, the player receives awards for all winning combinations where the playing card combinations are in an adjacent relationship in either a vertical column or a horizontal row. According to another embodiment, since each column and row represents a five card Poker hand, the cards of the winning combination need not be in adjacent positions. Thus a winning combination includes: (i) three or more playing cards, which are (ii) arranged in vertical columns or horizontal rows, (iii) starting in any column or row card location; (iv) appear in an enabled pay line and (v) represent a scheduled winning card combination.

At 40, for each winning combination, the player receives the corresponding award, which is preferably related to the amount wagered on the column/row where the winning combination appears. Thus, and with reference to FIG. 2, there is a winning outcome card combination in column B (Three Kings) and in row 1 (Five Card Straight) and in row 4 (Three Card Flush). For each winning outcome the player would receive a corresponding award.

After determining all winning outcome card combinations for the rows and columns, the processor 20 at 42 removes from the game matrix display the cards of the winning combinations. For example, the matrix, and with reference to the example and the cards of winning combinations, would be as follows (* designates the removed cards):

| | A | B | C | D | E |
|---|---|---|---|---|---|
| 1 | * | * | * | * | * |
| 2 | 7 | * | 2 | 10 | 4 |
| 3 | 4 | * | Q | 6 | A |
| 4 | A | 7 | * | * | * |
| 5 | 4 | 10 | 10 | A | A |

In one embodiment of the invention, after the cards of the winning outcomes are removed, at 44 adjacent cards which were not removed shift to the location of the removed cards and the matrix is reconstituted at the margins of the matrix with replacement cards selected from the data structure 36. To illustrate the shifting, cards may shift vertically downward prior to reconstitute the matrix as suggested below:

| | A | B | C | D | E |
|---|---|---|---|---|---|
| 1 | * | * | * | * | * |
| 2 | 7 | * | ⇓ | ⇓ | ⇓ |
| 3 | 4 | * | 2 | 10 | 4 |
| 4 | A | 7 | Q | 6 | A |
| 5 | 4 | 10 | 10 | A | A |

The processor 20 would randomly select, according to the example above, replacement cards at 34 to reconstitute the matrix to include a playing card in each card location as suggested below (reconstitution cards shown in bold).

| | A | B | C | D | E |
|---|---|---|---|---|---|
| 1 | 3 | J | J | 4 | 7 |
| 2 | 7 | 10 | 8 | 9 | 6 |
| 3 | 4 | Q | 2 | 10 | 4 |
| 4 | A | 7 | Q | 6 | A |
| 5 | 4 | 10 | 10 | A | A |

Reconstitution at 34 may also be done without shifting of vertically adjacent cards into the vacated card locations of the removed cards. That is, the processor 20 would simply select and display into the vacated card locations replacement cards.

Shifting could also be done horizontally, diagonally or in any combination of vertical, horizontal or diagonal.

At 40 the reconstituted display is again assessed by the processor 20 to determine if any new winning combinations have been created by reconstitution of the matrix. For example, a new Three Card Straight has been formed in column B and a Five Card Straight has been formed in row 2. For each newly formed winning card combination, the player would receive an award. The cards of the winning combination(s) would be removed and the matrix reconstituted by selection and display of new cards. This process is repeated until there are no winning combinations detected by the processor 20 in the game matrix whereupon the player is awarded the accumulated awards and the game hand is concluded.

At the end of each game hand or “deal”, the player may change his bet and play a new game, use the same wager and play a new game, view the help screen or the pay table, or cash out any credits that the player has accrued. Any suitable payout amounts may be used to award the player for winning combinations. The awards to the player, if any, may be made as each winning combination is determined or as the aggregate award at the end of the game.

As can be appreciated, the removal of the winning playing card combinations and reconstitution of the matrix in a recursive fashion provides the player with multiple opportunities to obtain winning combinations and awards. Further the game provides for excitement in that the player anticipates reconstitution resulting in new winning combinations with the playing cards which are added or with the pre-existing playing cards.

The device 10 and method of the present invention may be played in a Deuces Wild, Jokers Wild or Deuces Wild—Jokers Wild format as well. Still further, it may be played with certain designated combinations bearing an enhanced award, e.g. Four Aces with a Deuce, Three, or Four kicker.

In yet another embodiment, the game hand may end by one of a predetermined number of reconstitution cycles or may end by the appearance of one or more terminating playing cards or one or more playing card combinations.

While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims.

What is claimed is:

1. An electronic game device for a player comprising:
a) a display;
b) a game processor and a data structure storing data representing a deck of playing cards and data representing a predetermined award schedule for winning outcome card combinations;
c) a wager input apparatus for the player to input a wager and prompt play,
d) the game processor configured in response to prompting of play
(1) to control the display to show a selected playing card in each card location of a game matrix having columns C and rows R, where C and R are greater than or equal to 3,
(2) to compare the cards of the card locations to determine whether cards are disposed in at least one of a predetermined pattern defining a winning outcome card combination,
(3) to define the winning outcome card combination patterns as including at least a plurality of cards arranged in a column or row,
(4) to assign an award to each winning outcome card combination,
(5) to remove the cards of each winning outcome combination from the display,
(6) to display cards to replace the removed cards to reconstitute the game matrix, and
(7) to repeat steps (1) through (6) until there are no winning outcome card combinations.

2. The device of claim 1 comprising the data structure storing data corresponding to predetermined winning outcome card combinations arranged in either a horizontally adjacent row or a vertically adjacent column.

3. The device of claim 2 comprising the data structure storing data representing a deck of playing cards for each vertical column of the matrix and further comprising the processor configured to display cards selected from the corresponding deck into the card locations of each column.

4. The device of claim 3 comprising the data structure storing data representing one of a standard deck of fifty-two cards or a deck of fifty-two cards plus at least one Joker.

5. The device of claim 3 comprising the data structure storing data representing a schedule of winning card combinations each having at least three cards.

6. The device of claim 5 comprising the data structure storing data representing a schedule of winning card combinations of the group consisting essentially of:
Three of a Kind Three Card Straight Three Card Flush Four of a Kind Four Card Flush Five Card Full House Five Card Straight Five Card Flush Five Card Straight Flush Five Card Royal Flush Five of a Kind Five of the Same Card

7. The device of claim 3 comprising the data structure including at least one card designated as a wild card for determining winning outcome card combinations.

8. The device of claim 1 comprising the processor configured to display the game matrix as a 5×5 matrix.

9. The device of claim 1 comprising the processor configured to reconstitute the game matrix by controlling the display to re-position the card downward to fill the positions of the removed cards and selecting and displaying new cards to reconstitute the matrix.

10. A method for playing an electronic wagering game comprising:
a) providing an electronic display and a game computer processor storing in a data structure data representing playing cards and data representing a predetermined award schedule for winning outcome card combinations arranged in at least one or more patterns of vertically adjacent or horizontally adjacent in the game matrix;
b) the player making a wager allocated to one or more selected patterns to play the game, the game processor
(1) controlling the display to display a game matrix having C columns and R rows where C and R are greater than or equal to 3 and defining card locations, and
(2) displaying from the data structure a display of a playing card into each matrix card location;
c) the game processor also
(1) comparing the cards of the matrix to the schedule to determine if any of the wagered upon patterns includes at least one winning outcome card combination,
(2) for each winning outcome card combination the processor removing from the display of the playing cards thereof and selecting and displaying additional playing cards to reconstitute the game matrix to have a playing card for each card location,
(3) issuing an award to the player for each winning outcome card combinations according to the award schedule; and
(4) repeating steps (c)(1)-(c)(3); and
d) the processor concluding the game when it has determined there are no remaining winning outcome card combinations.

11. The method of claim 10 including:
(a) storing data representing a deck of playing cards for each vertical column of the matrix; and
(b) displaying cards selected from the corresponding deck into the card locations for each vertical column of the matrix.

12. The method of claim 10 including storing data representing either a standard deck of fifty-two cards or a deck of fifty-two cards plus at least one Joker.

13. The method of claim 11 including storing data defining winning outcome card combinations each having at least three cards.

14. The method of claim 13 including storing data representing a schedule of winning card combinations of the group consisting essentially of:
Three of a Kind
Three Card Straight
Three Card Flush
Four of a Kind
Four Card Flush
Five Card Full House
Five Card Straight
Five Card Flush
Five Card Straight Flush
Five Card Royal Flush
Five of a Kind
Five of the Same Card

15. The method of claim 10 including displaying the game matrix as a 5×5 matrix.

16. The method of claim 10 including designating a card as a wild card for determining winning outcome card combinations.

17. The method of claim 10 including reconstituting the game matrix by controlling the display to re-position the cards downward to fill the positions of the removed cards and displaying new cards to reconstitute the matrix.
